(19) United States
(12) Patent Application Publication
(10) Pub. No.: US 2013/0325465 A1
(43) Pub. Date: Dec. 5, 2013

(54) MEDICAL IMAGE READING SYSTEM

(71) Applicant: Advanced Medical Imaging and Teleradiology, LLC, (US)

(72) Inventors: Naiyer Imam, Roanoke, VA (US); Ron Mark, Jericho, NY (US)

(73) Assignee: ADVANCED MEDICAL IMAGING AND TELERADIOLOGY, LLC, Jericho, NY (US)

(21) Appl. No.: 13/683,524

(22) Filed: Nov. 21, 2012

Related U.S. Application Data
(60) Provisional application No. 61/563,219, filed on Nov. 23, 2011.

(51) Int. Cl. G10L 15/26

(52) U.S. Cl. CPC G10L 15/265
USPC 704/235

(57) ABSTRACT

A teleradiology processing system comprises a central reading station having a plurality of computer work areas, a plurality of transcriptionist stations each having a transcriptionist computer and a shared audio communication channel that facilitates audio communication between the central reading station and each of the transcriptionist stations. A database stores a plurality of medical case files, where the database is accessible by each of the plurality of transcriptionist computers. In operation, each transcriptionist computer takes control of a uniquely assigned one of the plurality of computer work areas of the central reading station to provide information from a pre-fetched medical case. Moreover, each transcriptionist computer prepares a report based upon a received code transmitted to the corresponding transcriptionist station over the shared audio communication channel. Each report, once approved by the specialist at the central reading station, is written to the database.

### CROSS-REFERENCE TO RELATED APPLICATIONS

This application claims the benefit of U.S. Provisional Patent Application Ser. No. 61/563,219, filed Nov. 23, 2011, the disclosure of which is hereby incorporated by reference in its entirety.

### BACKGROUND

The present disclosure relates to teleradiology systems and in particular, to systems that improve teleradiology throughput of medical image analysis and report generation.

Teleradiology comprises the transmission of radiological patient images and related information from one location to another for purposes of evaluation (e.g., interpretation or consultation). For instance, a hospital can capture medical images such as X-rays, magnetic resonance imaging (MRI) scans, computerized axial tomography (CAT) scans, etc., as digital medical image files. The hospital can then upload the captured medical image files to a remote image server. A corresponding domain expert (e.g., an MRI Radiologist, Neuroradiologist, etc.) can then retrieve the necessary medical image files from the remote image server for evaluation. Upon completing the evaluation, the domain expert submits a report back to the hospital. As such, the specialist and hospital do not need to be co-located.

### BRIEF SUMMARY

According to aspects of the present disclosure, a teleradiology system for processing medical images comprises a central reading station, at least one transcriptionist station, and a shared audio communication channel.

The central reading station is located at a centralized teleradiology location and includes a plurality of computer work areas. A single specialist (i.e., domain expert) utilizes each computer work area of the central reading station. Each transcriptionist station has a transcriptionist computer associated with a transcriptionist. The shared audio communication channel facilitates audio communication between the central reading station and each transcriptionist station.

Each transcriptionist computer is communicably coupled to a database. The database stores a plurality of medical case files where each medical case has at least one medical image. Each transcriptionist computer is also communicably coupled to a uniquely assigned one of the plurality of computer work areas of the central reading station.

In operation, each transcriptionist computer obtains a next medical case file from the database such that the transcriptionist computers collectively process through the medical case files. Additionally, each transcriptionist computer is operatively configured to take control of the uniquely assigned one of the plurality of computer work areas of the central reading station to provide information from the obtained medical case file. For instance, the transcriptionist computer provides information including at least one medical image to the assigned computer work area. Still further, each transcriptionist computer is operatively configured to prepare a report based upon a received code transmitted from the central reading station to the corresponding transcriptionist station over the shared audio communication channel. For instance, each transcriptionist computer provides the report to the assigned computer work area. Each report, once approved by the specialist at the centralized teleradiology location, is written to the database.

According to further aspects of the present disclosure, a method of processing medical images is provided. Image processing is performed by providing a central reading station having a plurality of computer work areas where the central reading station is associated with a single specialist at a centralized teleradiology location. The method further comprises connecting the central reading station with a plurality of transcriptionist stations, each transcriptionist station having a transcriptionist computer that is uniquely associated with a selected one of the plurality of computer work areas.

The method also comprises connecting each of the plurality of transcriptionist computers to a database that stores a plurality of medical case files, each medical case file having at least one medical image for analysis. Still further, the method comprises receiving at each one of the plurality of computer work areas, a next medical case file from the database. The next medical case file is received at the specialist computer work area by the uniquely associated transcriptionist computer obtaining the next medical case file from the database and by taking control of the uniquely associated one of the plurality of computer work areas to provide information from the obtained medical case file, including at least one medical image, to the uniquely associated computer work area.

The method also comprises communicating a code across a shared audio communication channel that facilitates audio communication between the specialist at the central reading station and each of the transcriptionist stations. Still further the method comprises receiving at each of the plurality of specialist work areas, a report prepared by the uniquely associated transcriptionist computer, where the report is based upon the code transmitted to the corresponding transcriptionist station over the shared audio communication channel. For instance, the received report may be presented to the assigned work area. Still further, the method comprises storing each report in the database once approved by the specialist at the centralized teleradiology location.

According to still further aspects of the present disclosure, another method of processing medical images is provided. The method comprises pre-fetching a first medical case file from a database by a first transcriptionist computer. The first medical file has at least one medical image and the first transcriptionist computer is associated with a first transcriptionist station. The method further comprises transferring at least one medical image of the first medical case file to a first computer work area of a central reading station. The first computer work area is remote from the first transcriptionist computer.

Similarly, the method comprises pre-fetching a second medical case file from the database by a second transcriptionist computer. The second medical file has at least one medical image. Moreover, the second transcriptionist computer is associated with a second transcriptionist station. The method still further comprises transferring at least one medical image of the second medical case file to a second computer work area of the central reading station. Here, the second computer work area is remote from the second transcriptionist computer and is co-located with the first computer work area.

The method yet further comprises communicating a first code corresponding to an analysis of the first medical case file across a shared audio communication channel from the central reading station to the first transcriptionist station and the second transcriptionist station, and generating a first report associated with the first medical case file that is provided within the first computer work area. The first report is derived from the first code by the first transcriptionist station. Similarly, the method comprises communicating a second code corresponding to an analysis of the second medical case file across the shared audio communication channel from the central reading station to the first transcriptionist station and the second transcriptionist station, and generating a second report associated with the second medical case file that is provided within the second computer work area. The second report is derived from the second code by the second transcriptionist station. The method further comprises sending the first report associated with the first medical case file to the database for storage and sending the second report associated with the second medical case file to the database for storage.

According to still further aspects of the present disclosure, a method for generating medical image reports is disclosed. The method comprises receiving at a first computer work area of a central reading station, a first medical case file including at least one medical image for evaluation by a specialist, where the first computer work area is remotely controlled by a first transcriptionist computer at a first transcriptionist station that is not co-located with the central reading station. Similarly, the method comprises receiving at a second computer work area of the central reading station, a second medical case file including at least one medical image for evaluation by the specialist. The second computer work area is remotely controlled by a second transcriptionist computer at a second transcriptionist station that is not co-located with the central reading station. Moreover, the second computer work area is co-located with the first computer work area at the central reading station. The method further comprises establishing a shared audio communication channel between the central reading station, the first transcriptionist station and the second transcriptionist station.

The method also comprises sending a first evaluation code over the shared audio communication channel to the first transcriptionist station and receiving at the first computer work area of the central reading station, a medical report associated with the first medical case file, wherein the details of the report are decoded from the first evaluation code. Similarly, the method comprises sending a second evaluation code over the shared audio communication channel to the second transcriptionist station and receiving at the second computer work area of the central reading station, a medical report associated with the second medical case file, wherein the details of the report are decoded from the second evaluation code. The method also comprises transmitting the report associated with the first medical case file, to a database for storage and transmitting the report associated with the second medical case file to the database for storage.

### BRIEF DESCRIPTION OF THE SEVERAL VIEWS OF THE DRAWINGS

FIG. 1 is an overall system diagram of a teleradiology system according to aspects of the present disclosure;

FIG. 2 is a block diagram illustrating the relationship between a central reading station and a plurality of transcriptionist stations, according to aspects of the present disclosure;

FIG. 3 is a flow chart illustrating an exemplary flow of medical image reading using the system of FIGS. 1 and 2, according to aspects of the present disclosure; and

FIG. 4 is a block diagram of a computer having computer readable program code for carrying out aspects of the present disclosure described more fully herein.

### DETAILED DESCRIPTION

According to various aspects of the present disclosure, systems, methods, and computer program products are provided that facilitate expeditious teleradiology image processing and report generation.

According to certain aspects of the present disclosure, a teleradiology system for processing medical images includes a centralized teleradiology location, a plurality of transcriptionist stations and a shared audio communication channel that facilitates audio communication between the centralized teleradiology location and each transcriptionist station. The teleradiology system also includes access to a database (e.g., accessed through a picture archiving and communication system (PACS) server), which stores a plurality of medical case files, each medical case file having at least one medical image for analysis.

The centralized teleradiology location includes at least one central reading station. Each central reading station is associated with a single specialist (e.g., a domain expert at interpreting MRI, CT, PET/CT, ultrasound, plain film, etc.) and includes a plurality of computer work areas.

Further, each transcriptionist station has a transcriptionist computer associated with a transcriptionist. Each transcriptionist computer is communicably coupled to the database to obtain a medical case file from the database. Each transcriptionist computer is also communicably coupled to a uniquely assigned one of the work areas of an associated central reading station. The transcriptionist computer takes control of the uniquely assigned computer work area to provide information from the obtained medical case file to a display of the assigned computer work area. In this manner, the specialist working at the central reading station has a plurality of computer work areas, each work area uniquely associated with a corresponding transcriptionist computer and correspondingly, a different medical case file.

Each transcriptionist computer is operatively configured to prepare a report based upon a code transmitted from the central reading station to the corresponding transcriptionist station over the shared audio communication channel. Each transcriptionist computer is also operatively configured to provide the report on the display of the assigned specialist computer work area, and once the report is approved by the specialist at the centralized teleradiology location, that report is written to the database.

Accordingly, the transcriptionist computers work as a team to queue medical image and other patient information, process the analysis from a specialist, and prepare and deliver reports to the corresponding work area of the central reading station, thus enhancing the workflow and efficiency of a teleradiology specialist. The transcriptionists are not required to be co-located with the specialist. In other words, the transcriptionists can be in a separate location from the specialist. As such, the specialist communicates with the transcriptionists (and transcriptionist computers) through the system of communication distributed between the central reading station operated by the specialist and the corresponding team of transcriptionist computers, each operated by a corresponding transcriptionist.

According to further aspects of the present disclosure, tools are provided to facilitate expedient report generation by the transcriptionist computer based upon interaction between a transcriptionist and a specialist. Codes are provided from the central reading station to an appropriate one of the transcriptionist stations (e.g., using the shared audio communication channel). The transcriptionist computer converts the codes into descriptions that are entered into, or otherwise become, a report (e.g., a report of medical findings based upon an interpretation by the specialist). Moreover, an optional random generator converts certain words or phrases of the descriptions into similar words (i.e., synonyms) or phrases to generate reports such that all of the reports generated are not identical.

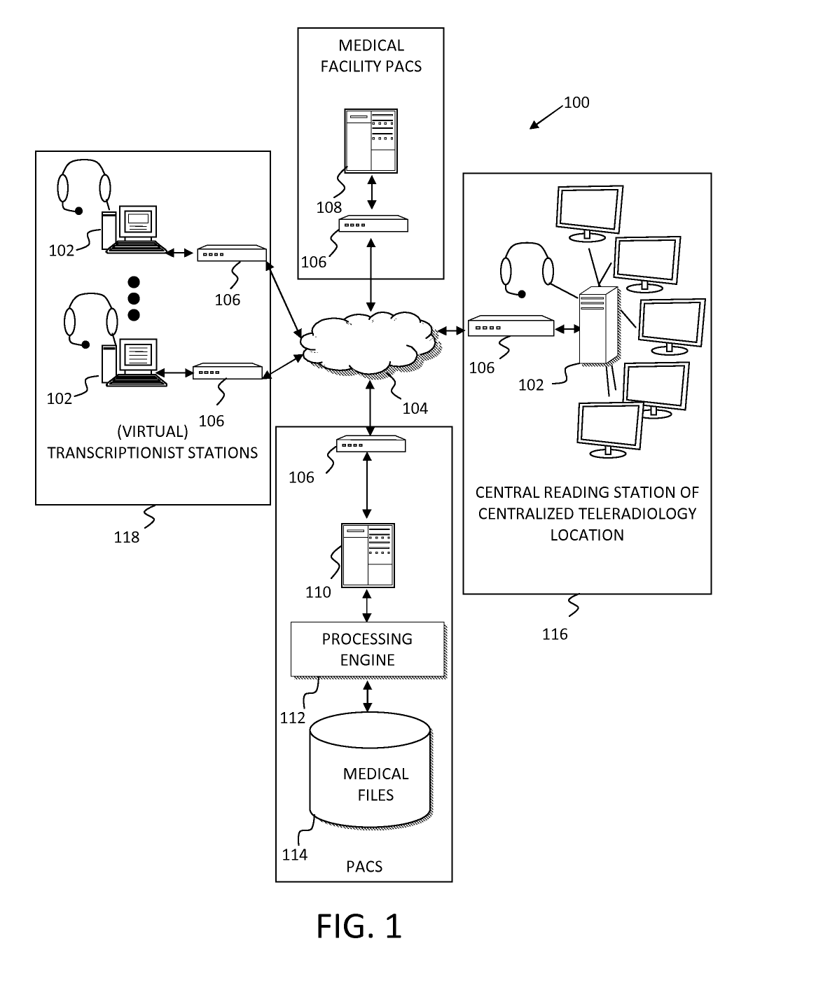

Referring now to the drawings and particularly to FIG. 1, a general diagram of a computer system 100 is illustrated according to various aspects of the present disclosure. The computer system 100 can be utilized to support a teleradiology system as will be described in greater detail herein. The computer system 100 comprises a plurality of hardware and/or software processing devices (designated generally by the reference 102) that are linked together by a network 104. Typical processing devices 102 include for example, personal computers, servers, notebook computers, transactional systems, purpose-driven appliances, and other devices capable of communicating over the network 104.

The network 104 provides communications links between the various processing devices 102, and may be supported by networking components 106 that interconnect the processing devices 102, including for example, routers, hubs, firewalls, network interfaces, wired or wireless communications links and corresponding interconnections, cellular and other telephone links, network switches, and/or other arrangements for enabling communication between the processing devices 102.

The illustrative system 100 includes a server 108 at a medical facility (e.g., a web server, file server or other processing device). The server 108 provides storage of, and access to, images from multiple modalities (i.e., images from various medical imaging technologies, such as magnetic resonance imaging (MRI), computerized tomography (CT), positron emission tomography (PET-CT), ultrasound, plain film X-ray, etc.). In this regard, the server 108 may comprise, for instance, a PACS server.

The illustrative system 100 also includes a server 110 (e.g., a web server, file server, PACS server, other processing device (or combinations thereof)) that supports a processing engine 112 and a corresponding database 114. The processing engine 112 and database 114 provide a centralized processing system that facilitates teleradiology image processing systems as described more fully herein.

In general, sources such as medical facilities require an expert to evaluate (e.g., interpret, diagnose, consult on, or otherwise review) medical image data. As such, the medical facility transfers a medical case file including at least one medical image from their server 108 (e.g., PACS server) to the server 110 (e.g., the PACS server of the teleradiology system). The specialists working for the teleradiology system review the medical case files sent to the PACS 110 and generate a report of the medical findings, which is communicated back to the requestor (e.g., the medical facilities associated with the PACS server 108).

According to various aspects of the present disclosure, a teleradiology system includes at least one centralized teleradiology location 116. The centralized teleradiology location 116 includes one or more specialist computer workstations, each specialist computer workstation referred to herein as a central reading station. Each central reading station is operated by a specialist (or a sub-specialist) at reading medical images and includes a plurality of computer work areas. Each computer work area may comprise a separate processing device 102 (e.g., a separate computer and corresponding separate display). Alternatively, a single processing device 102 may implement one or more computer work areas. In this regard, the processing device 102 may be coupled to a display per computer work area, or the processing device 102 may be coupled to a single display such that each computer work area is displayed in a corresponding display area within a relatively larger display. Regardless, each computer work area is uniquely allocated to processing a different medical case file. Thus, a single computer may run multiple instances of software, each software instance associated with a computer work area; a single computer may run multiple threads, each thread associated with a computer work area; a virtual machine operating on one or more physical machines may be uniquely allocated to each computer work area; multiple physical machines may be used such that there is a separate physical machine per computer work area; combinations thereof, etc.

For example, as illustrated, the processing device 102 of the teleradiology location 116 includes five displays (corresponding to at least five computer work areas) to illustrate the ability for a single specialist to process multiple medical case files at a time. However, in practice, any number of computer work areas may be implemented, depending upon the resources available to the specialist. In certain illustrative implementations, there are at least two computer work areas. Because a single specialist operates all of the computer work areas within a single central reading station, all computer work areas of that central reading station are co-located.

Further, as noted above, multiple computer work areas may be displayed on one display or display device. Keeping with the above example, the five computer work areas may be displayed on less than five displays. Thus, all five computer work areas can be displayed on one display. This allows the use of a single computer and display (e.g., a laptop computer), to run multiple computer work areas. In this implementation, navigation software is provided (e.g., via tab, index or otherwise) to allow the specialist to navigate from computer work area to computer work area. Still further, one display can include two or more computer work areas at the same time (e.g., by splitting the display screen, etc.).

As an example, a physical computer implementing the central reading station can run multiple virtual machines, where each virtual machine is associated with a corresponding computer work area. In such implementations, there will be one virtual machine for each work area. However, the virtual machines, and hence the computer work areas will share the number of available displays. Still further, any number of virtual machines can be executed, where each virtual machine runs one or more computer work areas. Thus, the computer work areas may be implemented by software executed by virtual machines such that the number of computer work areas is larger than the number of displays at the central reading station. In other implementations, any combination of physical displays and virtual machines may be utilized to implement the desired number of computer work areas. Still further, the virtual machines can be split across one or more physical computer devices.

The system 100 also includes at least one transcriptionist station 118. In operation, a transcriptionist station 118 is uniquely associated with a computer work area of the central reading station. In illustrative implementations, there is a unique transcriptionist station 118 for each computer work area. As an example, assume that there are five computer work areas corresponding to the five illustrated displays within the central reading station at the centralized teleradiology location 116. Thus, there are five transcriptionist stations 118 associated with the central reading station, each associated with a unique computer work area.

Each transcriptionist station includes a processing device 102 (e.g., a transcriptionist computer). In illustrative implementations, the transcriptionist computers are not co-located with the central reading station (i.e., the transcriptionist computers are separate from the central reading station). This allows transcriptionists to be distributed, even in completely different geographic locations, and still interact over the network 104 (e.g., the Internet) with the central reading station. Moreover, the various transcriptionist stations 118 do not need to be co-located with each other. Rather, the transcriptionist stations 118 can be distributed so long as the transcriptionist station 118 can access medical case files via the processing engine 112 and the database 114 of the server computer 110, and the transcriptionist station 118 can access the associated specialist computer work area, as will be described in greater detail herein.

As such, the server 110, processing engine 112 and medical files stored in the database 114 can be co-located with the centralized teleradiology location 116 or with one or more of the transcriptionist stations 118. Alternatively, the server 110, processing engine 112, and medical files stored in the database 114 can be remotely located from both the centralized teleradiology location 116 and the transcriptionist stations 116. Moreover, the server 110 can execute the virtual machines of the central reading station, or the virtual machines of the central reading station can be executed by other physical hardware (e.g., a desktop or laptop computer (or computers)). Likewise, the server 110 can execute the transcriptionist computers (e.g., as virtual machines) or the transcriptionist computers can be executed by separate hardware (e.g., a desktop or laptop computer (or computers)) at a remote location.

A transcriptionist operates a corresponding transcriptionist computer 102. In this regard, the “transcriptionist” can be a human operator, implemented as transcriptionist software, or both. In an illustrative implementation, the transcriptionist software includes voice recognition software capable of converting specialist instructions into a medical report.

Where the “transcriptionist” is a process (e.g., one or more applications executed in software, hardware, or combinations thereof) the process may be implemented in any practical manner. For instance, the transcriptionists can be implemented on a virtual machine on a server that is located at the centralized teleradiology location 116 or some other location. In this regard, the transcriptionist computer can be a stand-alone computer, a virtual machine, etc.

The transcriptionist software includes a “workflow manager” component that automates work flows. In an illustrative implementation, the workflow manager obtains a medical file from the database 114, takes remote computer control or shared computer control of the associated computer work area of a centralized reading station, and configures the display area associated with the specialist work area to output medical information related to the obtained medical file.

In general, the transcriptionist stations 118 cooperate with the specialist operating the central reading station to extract medical case files from the database 114, to generate medical reports, and to store the medical reports back out to the database 114 and/or submit the medical reports to the requesting source (e.g., the medical facility associated with server computer 108). As such, at times, the transcriptionist stations 118 are controlling, loading, configuring, or otherwise manipulating the computer work areas of the central reading station.

Accordingly, the teleradiology system, according to an illustrative implementation, can incorporate the server computer 110, the teleradiology location 116, transcriptionist stations 118, or combinations thereof, even though such features can be distributed across one or more networks, co-located, not co-located (i.e., remotely located), etc.

The system 100 also includes a shared audio communication channel (illustrated by the headsets), which provides an audio communication channel between the specialist working at a central reading station and each of the transcriptionists operating a corresponding transcriptionist station. The shared audio communication channel provides a second connection between each central reading station and each transcriptionist station 118, as will be described in greater detail herein.

The simplified illustration of FIG. 1 is provided for purposes of clarity of illustration and not limitation. For instance, although only one medical facility server 108 is illustrated, in practice, numerous medical facilities can send medical case files containing medical images to the server 110 of the teleradiology system for analysis. Moreover, although described using a PACS for convenience and clarity, the various aspects of the present disclosure are not limited to a PACS. Rather, any system can be utilized so long as the teleradiology specialist can view and analyze medical images. Further, in practice, one or more central reading stations can be utilized. In this regard, the central reading stations do not need to be co-located together. Still further, each central reading station can utilize multiple computer work areas. However, each central reading station can utilize a different number of computer work areas (e.g., some specialists may be comfortable working with five work areas, while others may be comfortable working with more or less than five work areas).

FIG. 1 is presented in schematic form. Thus, the server computers 108, 110 may schematically represent one or more servers, each server performing a different function. For instance, the server computer 110 may comprise any combination of web servers, file servers, back-end processing servers, etc., as is necessary to support the functionality of the processing engine 112 and database 114.

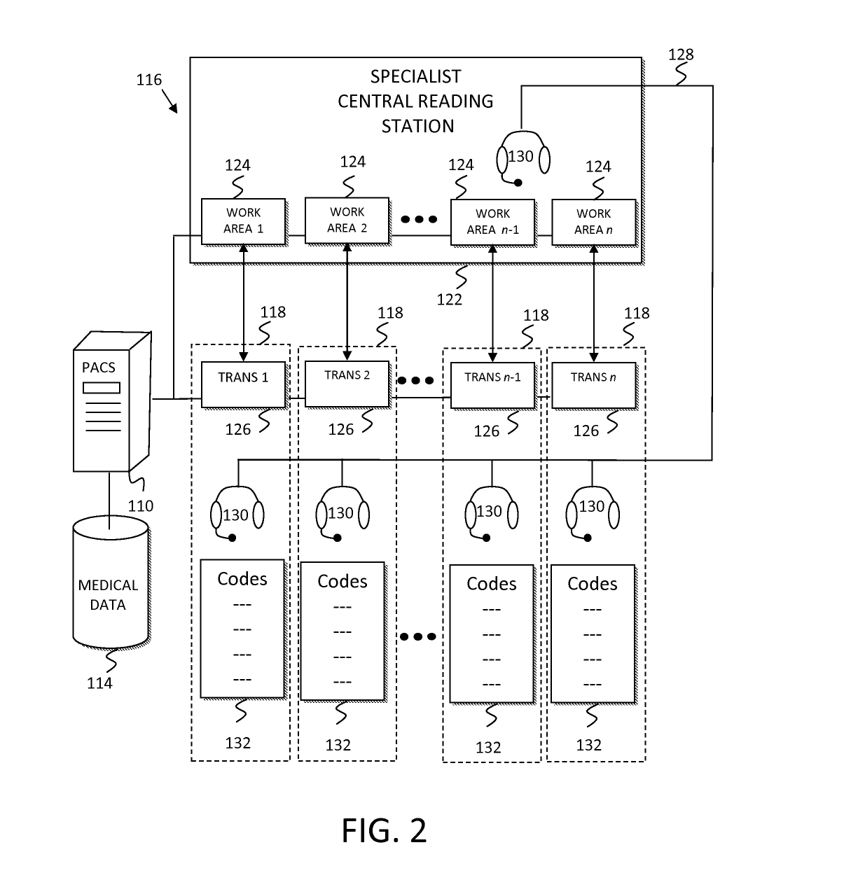

Referring to FIG. 2, an exemplary illustration is provided to demonstrate a simplified teleradiology system according to aspects of the present disclosure. The illustrated central teleradiology location 116 includes a single central reading station 122 (for clarity of discussion only), which is implemented as a specialist computer workstation. The central reading station 122 includes a plurality of computer work areas 124. For instance, there are n computer work areas illustrated where n>1 in this illustrative implementation. Each computer work area 124 independently executes the necessary software for processing a medical case file including the display and optional manipulation of image data associated with that case file. For instance, each computer work area 124 may be capable of executing word processing software, spreadsheet software, image processing software, report generating software, etc., necessary to complete a diagnosis and generate a report for a medical case file. Accordingly, the central reading station 122 is capable of displaying n separate medical case files at the same time. A single specialist operates the central reading station 122 as will be described in greater detail herein.

A plurality of transcriptionist stations 118 is also provided. For purposes of illustration, each transcriptionist station 118 includes a transcriptionist computer 126 that is not co-located with the central reading station 122 to illustrate the flexibility of the present disclosure. As noted herein, the transcriptionist stations 118 do not need to be co-located. In the illustrative implementation, the central reading station 122 and each of the transcriptionist computers 126 can access the server computer 110 and corresponding database 114 to access stored medical case files.

The system also includes a shared audio communication channel 128 that facilitates audio communication between the specialist at the central reading station 122 and each of the transcriptionist stations 118. For instance, an audio interface 130 such as a headset, separate microphone and speaker, telephone, conference call phone, speakerphone, etc., is provided for the specialist and at each transcriptionist station (e.g., for each transcriptionist). The audio interface 130 may alternatively be wired to the transcriptionist computer 126 where the transcriptionist is a virtual transcriptionist. The shared audio communication channel 128 may comprise a telephone connection, cellular, a voice over Internet protocol (VOIP) or other form of communication that allows audio communication between the specialist at the central reading station 122 and each transcriptionist station 118. In this regard, in certain implementations, the shared audio communication channel 128 is open so that all parties can communicate and listen to communications. The specialist at the central reading station 122 may also be able to control the shared audio communication channel 128, e.g. (to solo out one or more transcriptionists for communication while muting out other transcriptionists, so that only select transcriptionists are able to access the limited communication).

As will be described in greater detail herein, each transcriptionist computer 126 obtains a next medical case file from the database 114. Each transcriptionist computer 126 takes control of a uniquely assigned one of the plurality of computer work areas 124 of the central reading station 122 to provide information from the obtained medical case file, including at least one medical image, to a display or display area of the central reading station 122 that is associated with the corresponding computer work area 124. Each transcriptionist computer 126 prepares a report based upon a received code transmitted to the corresponding transcriptionist station 118 over the shared audio communication channel 128. For instance, the transcriptionist can be a person that receives the code by hearing the code announced by the specialist over the shared audio communication channel. The transcriptionist hearing the code generates the necessary report. Alternatively, the transcriptionist may comprise a virtual transcriptionist implemented by a computer operatively configured to automatically prepare the report based upon the received code transmitted from the central reading station. Here, the virtual transcriptionist can use computer code such as voice recognition code to translate the dictated code to text then the virtual transcriptionist can automatically parse the code and automatically generate the report as described more fully herein. Because each transcriptionist may be able to hear the dictated codes, the specialist identifies the computer work area to which the code is associated. That allows the transcriptionists to filter out non-relevant communications across the shared audio communication path.

Still further, the transcriptionist station 118 provides a prepared report to the assigned computer work area 124 of the central reading station 122. The report is displayed within the assigned work area 124, optionally along with the medical image(s) and/or other relevant information from the medical case file. Each report, once approved by the specialist at the central reading station 122, is written to the database 114 and is delivered to the intended recipient (e.g., the medical facility server 108 of FIG. 1).

For instance, as illustrated, a transcriptionist station 118 operating a transcriptionist computer 126 (designated TRANS 1) is assigned to, and is thus uniquely associated with a first work area 124, (designated WORK AREA 1) of a central reading station 122. A transcriptionist station 118 operating a transcriptionist computer 126 (designated TRANS 2) is assigned to, and is thus uniquely associated with a second work area 124, (designated WORK AREA 2) of the central reading station 122. A transcriptionist station 118 operating a transcriptionist computer 126 (designated TRANS n-1) is assigned to, and is thus uniquely associated with a second work area 124, (designated WORK AREA n-1) of the central reading station 122. Analogously, a transcriptionist station 118 operating a transcriptionist computer 126 (designated TRANS n) is assigned to, and is thus uniquely associated with a second work area 124, (designated WORK AREA n) of the central reading station 122.

The team of transcriptionist stations 118 works together with a single specialist operating the central reading station 122 to evaluate medical images. Each transcriptionist computer 126 remotely accesses the assigned work area 124 of the central reading station 122 of the specialist. Each transcriptionist computer 1)26 can also optionally share control of an associated computer work area 124 (e.g., with specialist at the central reading station 122 or with another transcriptionist computer 126. However, when the transcriptionist computer 126 has control, the assigned transcriptionist has full remote access to the specialist's computer work area 124 and can open, close, use programs and type so that the type is displayed on the display screen allocated to the work area 124.

Because of the separate communication line of the shared audio communication channel 128 (e.g., a telephone line, VOIP connection, cellular connection, etc.), the central reading station/specialist can also audibly communicate with each transcriptionist station 118 independently of the network based computer connection that shares data between the various computer work areas 124 and the transcriptionist computers 126.

As such, when the specialist is viewing an image at a given work area 124, (e.g., WORK AREA 1), a first communication path for data is established between the computer work area 124 (WORK AREA 1) and the associated transcriptionist computer (TRANS 1). Likewise, a second communication path distinct from the first communication path is established between the specialist operating the central reading station 122 and the transcriptionist (or virtual transcriptionist) operating the first transcriptionist station 118 via the shared audio communication channel 128. As such, the specialist can speak/dictate directly with the corresponding transcriptionist station 118 (e.g., the transcriptionist or virtual transcriptionist operating transcriptionist computer 126). Likewise, the transcriptionist (or virtual transcriptionist) can communicate back to the specialist across the communication line of the shared audio communication channel 128 independently of communication across the remote computer connection between TRANS 1 and WORK AREA 1 (for example).

According to further aspects of the disclosure herein, in certain implementations, the shared audio communication channel 128 is an open and shared channel of communication, meaning that each communication is broadcast so that the specialist and each transcriptionist has access to all communications. Alternatively, communication can be selective (e.g., the specialist selects the transcriptionist to communicate with, the specialist selects combinations of transcriptionists to communicate with, the specialist and all transcriptionists are on an open communication, i.e., the shared audio communication channel 128 can be used for broadcast, one-to-one or one-to-many communications).

Each transcriptionist station 118 utilizes transcription codes 132 that represent the most common diagnoses associated with the types of images that the specialist reads. Thus, the specialist can look at an image within a computer work area 124 that is posted by the assigned transcriptionist. The specialist can then verbally communicate a transcription code over the shared audio communication channel 128 (e.g., the open telephone line, VOIP, cellular connection, etc.). The associated transcriptionist then enters the transcription code into a computer program, and the computer program automatically pulls up a medical report corresponding to the transcription code entered by the transcriptionist.

Thus, when the specialist transitions from one computer work area 124 to the next, the assigned transcriptionist station 118 already has a case loaded onto the display screen of the associated work area 124. The specialist takes a moment to evaluate the medical case file. This may comprise, for instance, bringing up, zooming, processing or otherwise evaluating the image(s) associated with the medical case file, reading text, etc. Then, the specialist communicates the appropriate transcription code across the shared audio communication channel 128. The assigned transcriptionist at the associated transcriptionist station 118 causes a report to be automatically generated, and that automatically generated report appears on the display screen of the corresponding work area 124.

At this point, in some occasions, the specialist may make a minor change in the report, such as communicating the changes across the communication channel 128 to the assigned transcriptionist at the corresponding transcriptionist station 118. In this regard, the specialist views the report in the same computer work area 124 as the displayed medical record. As such, the specialist gives each medical file at least two looks: a first look for evaluation before the report is generated and a second look after the report is generated. This approach improves accuracy of evaluation because the report can be reviewed/audited by the specialist directly against the medical case file, including the medical image(s). Otherwise, the report is done.

While the attention of the specialist is focused on a first one of the computer work areas 124, the remaining transcriptionists at the associated transcriptionist stations 118 are queuing new medical case files, preparing reports, sending reports, etc. As such, the specialist does not spend time on purely administrative tasks, and the specialist does not spend time loading, formatting, sending, or otherwise processing reports and/or case information.

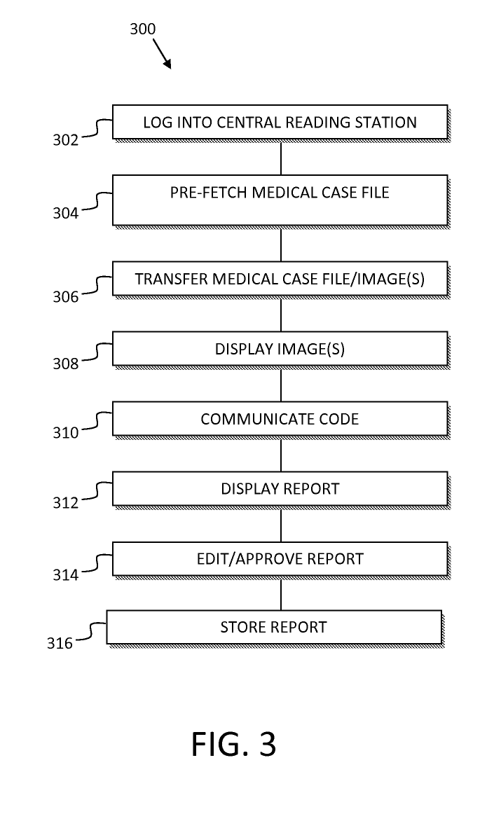

Referring to FIG. 3, a method 300 illustrates an exemplary approach for reading medical images using a teleradiology system, such as described above in reference to the FIG. 2. The method 300 may be implemented, for instance, as executable program code (e.g., stored on a computer-readable storage device) where the program instructs a processor to perform the method 300. The method may also be implemented by a computer system having a processor coupled to memory, where the memory has executable program code stored thereon, and the executable program code instructs the processor to perform the method 300.

A specialist logs into the central reading station at 302. A transcriptionist station (which does not need to be co-located with the specialist) is uniquely associated with each computer work area of the central reading station. As such, if the central reading station includes five work areas, there are five separate transcriptionist stations, one transcriptionist station uniquely associated with a corresponding computer work area.

A first software component allows each transcriptionist station to access and control the corresponding assigned computer work area of the central reading station. In an illustrative implementation, each transcriptionist station can gain control of only one computer work area (one-to-one relationship). However, this data communication is two-way so that at a given time, either the associated transcriptionist operating the transcriptionist station or the specialist operating the computer work area can control the corresponding computer work area. In alternative implementations, a transcriptionist station may be configured to process more than one computer work area (e.g., where a transcriptionist station includes two windows or separate transcription areas to keep the transcriptionist activities associated with each computer work area separate).

There is also a shared audio communication channel (e.g., common/shared voice communication line) connecting the specialist to all of the transcriptionists. As such, the specialist can speak/dictate to one or more transcriptionists of the transcriptionist team asynchronously. According to certain exemplary implementations, the shared audio communication channel is also a two-way communication channel in that the specialist and transcriptionists can each speak and hear communications across the shared audio communication channel. Moreover, the shared audio communication channel can be shared so that all transcriptionists of the transcription team can communicate, even amongst themselves, in an asynchronous manner (e.g., such as a telephone line that is open between the teleradiology location and each transcriptionist station simultaneously like a party line or conference call, or a voice over Internet protocol (VOIP) that is open between the teleradiology location and each transcriptionist station simultaneously). According to illustrative implementations, the shared audio communication channel is controlled at the teleradiology location to be selectively open between the teleradiology location and each transcriptionist station simultaneously.

Each transcriptionist has a series of transcription codes, where each code represents a diagnosis or other element to be included in a corresponding report. Codes are dictated by the specialist to each transcriptionist station, and the corresponding transcriptionist station uses the codes to generate a medical report. More particularly, according to aspects of the present disclosure, the specialist “batch processes” medical image interpretations in a two-step process. The first step is an evaluation process, and the second step is a verification process.

The evaluation process comprises pre-fetching medical case files at 304, transferring medical images to corresponding work areas at 306, and displaying the transferred medical images at 308. The specialist communicates a code corresponding to the medical case file being evaluated at 310 (e.g., across a shared audio communication channel to the assigned transcriptionist).

For instance, each transcriptionist station pre-fetches and loads a medical case file onto the corresponding computer work area of the central reading station by drawing a next case from a queue in the PACS server or other suitable database. By taking control of the assigned work area, each transcriptionist computer transfers/preloads at least one medical image of the pre-fetched medical case file to the assigned work area of the central reading station such that the medical case file information is displayed in an associated display area. The transcriptionist computer, through remote control, can also optionally load other suitable information into the associated work area. For instance, the transcriptionist computer can load information such as the medical history of the patient, the age of the patient, etc. The transcriptionist computer can also/alternatively provide comparison images, such as one or more baseline images, or the transcriptionist computer can remotely control and load other information into the computer work area of the associated central reading station that would assist the specialist in performing the diagnosis.

As such, the specialist has all of the information necessary to make a medical diagnosis available in a computer work area without the need to perform any administrative tasks to obtain the information directly. Moreover, the computer work area may provide necessary image processing tools for the specialist to interact with the information and medical image(s) to that the specialist can make an informed diagnosis. In an illustrative example, the work area comprises computer aided design (CAD) style software that manipulates the medical image(s) (e.g., to zoom, pan, suppress features, and perform other manipulations necessary to properly evaluate the medical case file).

The specialist can then step serially through the computer work areas. At each computer work area, the specialist manipulates the medical case file data that has been preloaded by the associated transcriptionist station.

The specialist then provides a code to the associated transcriptionist over the shared audio communication channel, where the code corresponds to the diagnosis. For instance, the specialist can dictate the code. The code can represent a diagnosis or other information to be entered into a report. As an alternative illustrative example, each code can define a type, style, format, etc. of the report. Still further, a plurality of pre-drafted reports can be provided. In this regard, the code indicates the report to be selected for the associated medical case file. In such a circumstance, the report can be further edited, customized, modified, etc.

The specialist then goes onto the next computer work area and interacts with the next transcriptionist station in an analogous manner. As the specialist is evaluating the next case, the transcriptionist associated with the previous evaluated case is preparing the report based upon the previously dictated code. The specialist does not need to go in any particular order within the group of computer work areas, so long as the medical case file is pre-loaded and is ready for evaluation by the time that the specialist gets to that computer work area. As such, the specialist can freely interact with the various computer work areas and dictate medical diagnosis via medical codes in an efficient manner. Moreover, the codes are transformed by the transcriptionist stations in-line so that the specialist does not waste time waiting for the codes to be transformed into reports.

In the verification process, each report prepared by a transcriptionist is displayed at the corresponding computer work area at 312. The specialist can review, optionally edit, and approve the reports at 314. The approved reports are saved back out to the database (e.g., PACS) at 316.

Keeping with the above example, the specialist goes back through the computer work areas where a code has been dictated and reviews each report that has been generated by the associated transcriptionist based upon the received code. At this time, the specialist can request that the transcriptionist make changes (e.g., via the shared audio communication channel). The specialist may alternatively make changes directly to the report. Once approved, the specialist closes out the report. The associated transcriptionist sends the report out and draws the next case from the queue in the PACS server. When the specialist has signed off on each report, the next batch of cases is started and the above process repeats.

According to further aspects of the present disclosure, the report generator and correspondingly, the codes, are logically organized by body part/region. For instance, in an exemplary implementation, a plurality of different programs, modules, code sections, etc., are provided to specifically address the unique nature of the body part/region to be evaluated. By way of illustration, and not by way of limitation, a chest image can comprise a separate program, module, subroutine, etc. in a larger program that also accommodates different body parts. This allows the software to focus the report facilities on the key elements of the medical image. For instance, in a chest image, a specialist may be interested in inspecting features such as the heart, lungs, pulmonary vessels, costophrenic angles, etc. Each feature may have a different specification of classification (e.g., in terms of degree). As such, the report generator is “tuned” to uniquely address the issues of a chest image by understanding the features of the image, and the areas that the specialist is to inspect. In this regard, the report generating software is configured to comply with local, state, and federal standards and regulations (e.g., following the American College of Radiology (ACR) standards).

According to aspects of the present disclosure, the code that the specialist dictates over the shared audio communication channel is a concatenation of the entire diagnosis. As such, in certain cases, a single announced code consolidates the diagnosis for the entire associated report. The code is parsed by the transcriptionist to decipher the complete diagnosis.

In an illustrative example, each code is logically broken down into a three-part string that includes a concatenation of the body part/area, the diagnosis and the degree associated with the diagnosis, not necessarily in that order. Moreover, the codes may be based upon a categorization such as trauma, infection, neoplasm, vascular, idiopathic, other, etc.

By way of example, a specialist may evaluate a case and then dictate over the common communication line, the code: 211RULC01. The corresponding transcriptionist that is uniquely associated with the corresponding transcriptionist computer parses this code into three fields, each field three characters long. For instance, 211=pneumonia; RUL=Right Upper Lobe; C=cardiomegaly, 01=no osteoporosis, mild osteoarthritis. Here, the third field is broken down into two sub-fields for purposes of illustration. The transcriptionist thus prepares a report diagnosing pneumonia in the right upper with cardiomegaly, showing no osteoporosis but mild osteoarthritis. In practice, any number of codes can be used. Moreover, the coding can take any number of formats. The system advantageously generates reports using consistent terminology. Moreover, the report generator translates the diagnosis into a format that flows, looks and reads like a report. This has an advantage of providing consistent and proper language despite using different transcriptionists in the report generating process.

According to further aspects of the present disclosure, the system further uses a random generator to replace at least one expression in the report with a differently worded but equivalent expression. For instance, the system uses an equivalency function to randomly replace certain key terms with synonyms/equivalents. Thus, if the specialist dictates the same code twice, it is possible that the literal verbiage of each report will be different, but the substance will be identical.

According to still further aspects of the present disclosure, the report generator provides the ability to save “instant clicks” to an “instant click menu” or other logical arrangement. This allows for words, phrases, sentences, one-liner additions, etc. that occasionally appear in reports to be quickly and easily pulled up and automatically inserted into the generated report. By way of example, a specialist evaluating X-rays (or transcriptionist assisting a specialist evaluating X-rays) may set an instant click for the one-liners “median sternotomy wires are noted, which appear intact,” and “right/left central venous catheter is present with tip located in the superior vena cava.” If an “instant click” is executed, the associated text appears in the report. Also, multiple additions can be added at one time. In certain illustrative implementations of the present disclosure, the report generator also includes the ability to add a “comparison date” if there is a prior exam. In this implementation, the system allows the ability to instant click on “improved,” “worsened,” “resolved,” “unchanged” with options of “mildly improved,” “mildly worsened,” “partial resolution,” “complete resolution,” etc. In practice, the text entered into the report can utilize the same verbiage as that associated with the meaning of the corresponding “instant click” button, or the text entered into the report can include more thorough verbiage reciting the meaning of the corresponding “instant click.”

Thus, each report can comprise a combination of template/automated content, transcriptionist entered content and optionally, specialist entered content. Moreover, regardless of the source of content, the report generator, according to certain aspects of the present disclosure, can dynamically randomize key words and phrases to use synonym/equivalent expressions. Still further, an overall report can consist of specialist transcribed edits, personalization, etc.

According to further aspects of the present disclosure, the specialist analyzes the medical image and is then almost immediately presented a transcribed report on the findings that states conclusions. As such, the specialist can approach a medical case file quickly and apply two different mindsets, first a mindset to analyze the medical image(s) and then a mindset to verify the accuracy of a report that sets forth the findings of the medical evaluation. Moreover, both evaluations can be carried out with the medical images in view for inspection, re-verification, a second look, etc.

In an exemplary implementation, a radiologist can increase the number of case files read per hour, and in some instances, may be able to significantly increase the number of cases read per hour compared to using conventional approaches. This increase in productivity can also create an increase in accuracy because the report is displayed back to the specialist quickly. Moreover, the specialist sees the report along with the medical image(s) and case file information, providing two or more fresh reads through the medical case file. As the report and case file are presented at the same time, there is an increase in accuracy because the verbiage of the report providing medical findings can be directly compared to the medical report and images.

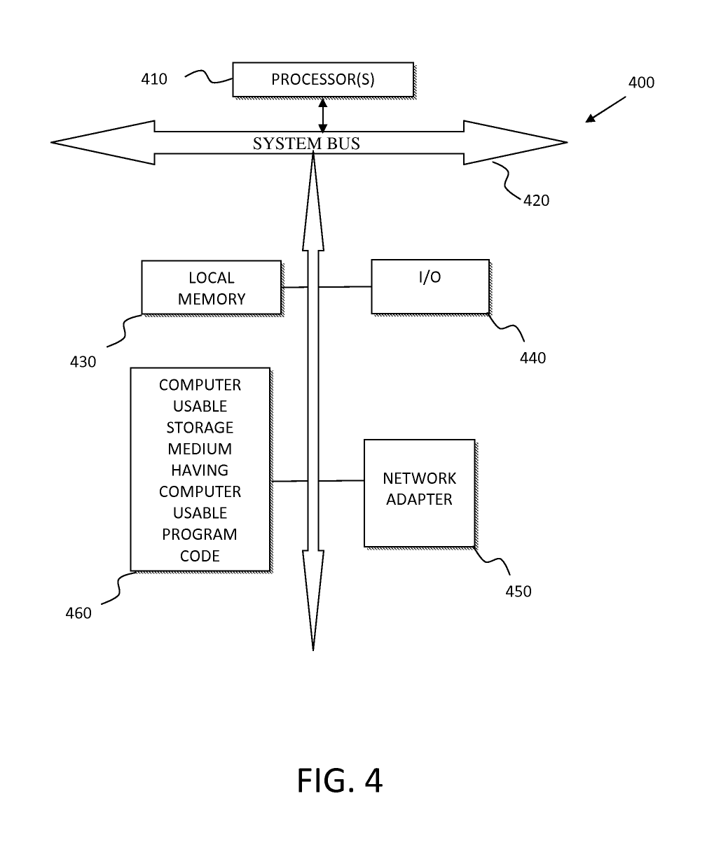

Referring to FIG. 4, a block diagram of a system of a data processing device (e.g., a computer described in FIGS. 1 and/or 2), is depicted in accordance with the present disclosure. Data processing system 400 may comprise one or more processors 410 connected to system bus 420. Also connected to system bus 420 is memory controller/cache that provides an interface to local memory 430. An I/O bus bridge provides an interface to an I/O bus that supports one or more buses and corresponding devices such as input output devices (I/O devices) 440. A network adapter 450 enables the data processing system to communicate with other devices through intervening private or public networks.

Also connected to bus is storage 460, which includes a computer usable storage medium having computer usable program code embodied thereon. The computer usable program code is executed to implement any aspect of the present disclosure, for example, to implement any aspect of any of the methods and/or system components illustrated in FIGS. 1-3. Moreover, the computer usable program code may be utilized to implement any other processes that are associated with teleradiology, or other aspects as set out further herein.

As will be appreciated by one skilled in the art, aspects of the present disclosure may be embodied as a system, method or computer program product. Accordingly, aspects of the present disclosure may take the form of an entirely hardware embodiment, an entirely software embodiment or an embodiment combining software and hardware aspects. Furthermore, aspects of the present disclosure may take the form of a computer program product embodied in one or more computer readable storage medium(s) having computer readable program code embodied thereon.

Any combination of one or more computer readable medium(s) may be utilized. A computer readable storage medium may be, for example, but not limited to, a portable computer diskette, a hard disk, a random access memory (RAM), a read-only memory (ROM), an erasable programmable read-only memory (EPROM or Flash memory) or any suitable combination of the foregoing. A computer readable storage medium may be any tangible medium that can contain or store a program for use by or in connection with an instruction execution system, apparatus, or device.

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks and/or provide processes for implementing the functions/acts specified in the flowchart and/or block diagram block or blocks.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the disclosure in the form disclosed. Many modifications and variations will be apparent to those of ordinary skill in the art without departing from the scope and spirit of the disclosure.

Having thus described the invention of the present application in detail and by reference to embodiments thereof, it will be apparent that modifications and variations are possible without departing from the scope of the invention defined in the appended claims.

What is claimed is:

1. A teleradiology system for processing medical images, comprising:
a central reading station having a plurality of computer work areas, the central reading station associated with a single specialist;
at least one transcriptionist station, each transcriptionist station having a transcriptionist computer associated with a transcriptionist; and
a shared audio communication channel that facilitates audio communication between the central reading station and each transcriptionist station;
wherein:
each transcriptionist computer is communicably coupled to a database that stores a plurality of medical case files to obtain a next medical case file from the database, each medical case file of the database having at least one medical image for analysis;
each transcriptionist computer is operatively configured to take control of a uniquely assigned one of the plurality of computer work areas to provide information from the obtained medical case file, including at least one medical image, to the assigned computer work area;
each transcriptionist computer is operatively configured to generate a report based upon a received code transmitted from the central reading station to the corresponding transcriptionist station over the shared audio communication channel and provide the report to the assigned computer work area; and
each report, once approved by the specialist at the centralized teleradiology location, is written to the database.

2. The system according to claim 1, wherein the database is part of a picture archiving and communication system (PACS).

3. The system according to claim 1, wherein the shared audio communication channel is controlled at the teleradiology location to be selectively open between the teleradiology location and each transcriptionist station simultaneously.

4. The system according to claim 1, wherein the shared audio communication channel comprises a telephone line that is open between the teleradiology location and each transcriptionist station simultaneously.

5. The system according to claim 1, wherein the shared audio communication channel comprises a voice over Internet protocol (VOIP) that is open between the teleradiology location and each transcriptionist station simultaneously.

6. The system according to claim 1, wherein at least one transcriptionist comprises a virtual transcriptionist comprising a computer operatively configured to automatically prepare the report based upon the received code transmitted from the central reading station across the shared audio communication channel.

7. The system according to claim 1, wherein each transcriptionist station is located separately from the central reading station.

8. The system according to claim 1, wherein each transcriptionist station provides a report to the work area while the medical case file, including at least one medical image, is also provided in the work area.

9. The system according to claim 1, wherein the at least one transcriptionist station comprises a plurality of transcriptionist stations, which includes at least one transcriptionist station for each work area of the central reading station.

10. The system according to claim 1, wherein each received code transmitted from the central reading station over the shared audio communication channel encodes an entire diagnosis associated with the medical case file.

11. The system according to claim 1, wherein each transcriptionist computer is operatively configured to parse the communicated code into a plurality of fields, each field corresponding to a different part of the diagnosis in order to generate the report.

12. The system according to claim 1, wherein each transcriptionist computer further comprises a random generator to replace at least one expression in the report with a differently worded but equivalent expression.

13. A method of processing medical images, comprising:
providing a central reading station having a plurality of computer work areas, each work area associated with a single specialist at a centralized teleradiology location;
connecting the central reading station with a plurality of transcriptionist stations, each transcriptionist station having a transcriptionist computer that is uniquely associated with a selected one of the plurality of computer work areas;
connecting each of the plurality of transcriptionist computers to a database that stores a plurality of medical case files, each medical case file having at least one medical image for analysis;
receiving at each one of the plurality of computer work areas, a next medical case file from the database, wherein the next medical case file is received by the uniquely associated transcriptionist computer:
obtaining the next medical case file from the database; and
taking control of the uniquely associated one of the plurality of computer work areas to provide information from the obtained medical case file, including at least one medical image, to the uniquely associated computer work area;
communicating a code across a shared audio communication channel that facilitates audio communication between the specialist at the central reading station and each of the transcriptionist stations;
receiving at each of the plurality of specialist work areas, a report prepared by the uniquely associated transcriptionist computer, where the report is based upon the received code transmitted to the corresponding transcriptionist station over the shared audio communication channel; and
storing each report in the database once approved by the specialist at the centralized teleradiology location.

14. The method according to claim 13, wherein communicating a code comprises communicating a code that encodes an entire diagnosis associated with the medical case file.

15. The method according to claim 13 further comprising generating the report by parsing the communicated code into a plurality of fields, each field corresponding to a different part of the diagnosis.

16. The method according to claim 13 further comprising using a random generator to replace at least one expression in the report with a differently worded but equivalent expression.

17. The method according to claim 13, wherein receiving at each of the plurality of specialist work areas, a report prepared by the uniquely associated transcriptionist computer, further comprises providing the report along with the medical case file, including at least one medical image within the associated computer work area.

18. The method according to claim 13, wherein communicating a code across a shared audio communication channel comprises communicating the code across a voice over Internet protocol (VOIP) that is open between the teleradiology location and each transcriptionist station simultaneously.

19. A method of processing medical images comprising:
pre-fetching a first medical case file from a database by a first transcriptionist computer, wherein the first medical file has at least one medical image and the first transcriptionist computer is associated with a first transcriptionist station;
transferring at least one medical image of the first medical case file to a first computer work area of a central reading station, wherein the first computer work area is remote from the first transcriptionist computer;
pre-fetching a second medical case file from the database by a second transcriptionist computer, wherein the second medical file has at least one medical image and the second transcriptionist computer is associated with a second transcriptionist station;
transferring at least one medical image of the second medical case file to a second computer work area of the central reading station, wherein the second computer work area is remote from the second transcriptionist computer and is co-located with the first computer work area;
communicating a first code corresponding to an analysis of the first medical case file across a shared audio communication channel from the central reading station to the first transcriptionist station and the second transcriptionist station;
generating a first report associated with the first medical case file that is provided within the first computer work area, wherein the first report is derived from the first code by the first transcriptionist station;
sending the first report associated with the first medical case file to the database for storage;
communicating a second code corresponding to an analysis of the second medical case file across the shared audio communication channel from the central reading station to the first transcriptionist station and the second transcriptionist station;
generating a second report associated with the second medical case file that is provided within the second computer work area, wherein the second report is derived from the second code by the second transcriptionist station; and
sending the second report associated with the second medical case file to the database for storage.
